(19) United States
(12) Patent Application Publication
(10) Pub. No.: US 2025/0027355 A1
(43) Pub. Date: Jan. 23, 2025

(54) METHOD AND APPARATUS FOR PROVIDING TAKE-OUT SERVICE BY USING AN AUTONOMOUS VEHICLE

(71) Applicants: HYUNDAI MOTOR COMPANY, Seoul (KR); KIA CORPORATION, Seoul (KR)

(72) Inventors: Jung Seok Suh, Yongin-si (KR); Hong Seok Yang, Hwaseong-si (KR); Ja Yoon Goo, Anyang-si (KR); Min Taek Jeon, Seoul (KR)

(73) Assignees: HYUNDAI MOTOR COMPANY, Seoul (KR); KIA CORPORATION, Seoul (KR)

(21) Appl. No.: 18/678,014

(22) Filed: May 30, 2024

(30) Foreign Application Priority Data
Jul. 19, 2023 (KR) 10-2023-0093585

(51) Int. Cl. E05F 15/70; G06Q 10/087

(52) U.S. Cl. CPC E05F 15/70; G06Q 10/087; E05Y 2900/531; E05Y 2900/548; E05Y 2900/55

(57) ABSTRACT

A method and an apparatus for providing unmanned take-out service of an autonomous vehicle are provided. The apparatus includes an order information receiving unit configured to receive product order information from a user terminal. The apparatus also includes an order information providing unit configured to provide details of an ordered product included in the product order information to a product provider of the ordered product. The apparatus also includes an order processing recognition unit configured to recognize the ordered product provided from the product provider. The apparatus also includes a controller configured to control at least one of a seat, a window, a door, or a trunk of a vehicle according to a position in the vehicle of a loading target space for the ordered product.

### CROSS-REFERENCE TO RELATED APPLICATION

This application claims priority to Korean Patent Application No. 10-2023-0093585, filed on Jul. 19, 2023 in Korea, the entire contents of which are incorporated herein by reference.

### TECHNICAL FIELD

The present disclosure relates to an apparatus and method for providing unmanned take-out service by an autonomous vehicle.

### BACKGROUND

The content described below simply provides background information related to the present embodiment and does not constitute prior art.

In the autonomous vehicle unmanned take-out technology, when an orderer wants to purchase a product, he or she orders the product and moves the autonomous vehicle to the store, and then the autonomous vehicle receives the product from the store and delivers the product. In addition, when the autonomous vehicle receives the product from the store into a loading space of the vehicle, a method of preventing deterioration of the product by maintaining an appropriate temperature inside the loading space according to the temperature of the product is also provided.

However, in the related art, if there are other items of the orderer stored in the loading space of an autonomous vehicle that is moved autonomously to deliver the product, it may not be easy for the orderer to smoothly receive the ordered product. In addition, there may be a case in which the other items of the orderer stored in the loading space of the vehicle may be unnecessarily exposed to the clerk. This causes a problem of protecting the orderer's privacy.

### SUMMARY

In view of the above, the present disclosure provides an apparatus and method for providing unmanned take-out service by an autonomous vehicle.

The problems to be solved by the present disclosure are not limited to the problems mentioned above, and other problems not mentioned should be clearly understood by those having ordinary skill in the art from the description below.

According to an aspect of the present disclosure, an apparatus for providing unmanned take-out service of an autonomous vehicle includes an order information receiving unit configured to receive product order information from a user terminal. The apparatus also includes an order information providing unit configured to provide details of an ordered product included in the product order information to a product provider of the ordered product. The apparatus also includes an order processing recognition unit configured to recognize the ordered product provided from the product provider. The apparatus also includes a controller configured to control at least one of a seat, a window, a door, or a trunk of a vehicle according to a position in the vehicle of a loading target space for the ordered product.

According to another aspect of the present disclosure, a method for providing unmanned take-out service of an autonomous vehicle includes performing an order information receiving process by receiving product order information from a user terminal. The method also includes performing an order information providing process by providing details of an ordered product included in the product order information to a product provider of the ordered product. The method also includes performing an order processing recognizing process by recognizing the ordered product provided from the product provider. The method also includes performing a control process by controlling at least one of a seat, a window, a door, or a trunk of a vehicle according to a position of a loading target space in the vehicle for the ordered product.

According to an embodiment of the present disclosure, when using an autonomous vehicle, the vehicle may go to a desired position autonomously and perform tasks, such as pick-up or take-out services as needed, even without an occupant in the vehicle. In particular, a vehicle owner may be provided with a take-out/pick-up service using the autonomous vehicle even in a situation in which the vehicle owner is unable to move directly.

The autonomous vehicle recognizes and makes decisions on its own and carries out authentication and security-related procedures, so that the authentication process is strengthened by performing clerk authentication and product authentication even when a privately owned unmanned vehicle performs a task.

Even if there are other existing items on a vehicle seat, a seat requiring security is swiveled during a take-out/pick-up service so that the seat requiring security is not visible from the outside, only a space permitted for loading ordered products is allowed to have a light turned on to automatically lock a small box, and only a windows or door necessary for loading ordered products is opened, while the remaining windows or doors are locked. Thus, a security function is strengthened.

When a seller approaches an unauthorized space when loading products, a warning is given and recording is conducted, and thus theft of goods in the vehicle is prevented.

The effects of the present disclosure are not limited to the effects mentioned above, and other effects not mentioned may be clearly understood by those having ordinary skill in the art from the description below.

### BRIEF DESCRIPTION OF THE DRAWINGS

FIG. 1 is a diagram illustrating an autonomous vehicle 10 equipped with an unmanned take-out service providing apparatus 100 according to an embodiment of the present disclosure.

FIG. 2 is a block diagram illustrating a configuration of the unmanned take-out service providing apparatus 100 according to the present embodiment.

FIG. 3 is a diagram illustrating a form in which an autonomous vehicle 10 identifies a seller 20.

FIG. 4 is a diagram illustrating a lighting control situation within the vehicle 10 when an ordered product 21 is loaded into the autonomous vehicle 10.

FIG. 5 is a diagram illustrating a security locking situation inside the vehicle 10 when the ordered product 21 is loaded into the autonomous vehicle 10.

FIG. 6 is a diagram illustrating an example of swiveling at least one seat ST1, ST2, ST3, and ST4 according to a position of the seats ST1, ST2, ST3, and ST4 on which an ordered product 20 is loaded.

FIG. 7 is a flowchart illustrating a method of providing an unmanned take-out service according to an embodiment of the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components instead of excluding thereof unless specifically stated to the contrary.

The following detailed description, together with the accompanying drawings, is intended to describe embodiments of the present disclosure and is not intended to represent the only embodiments in which the present disclosure may be practiced. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

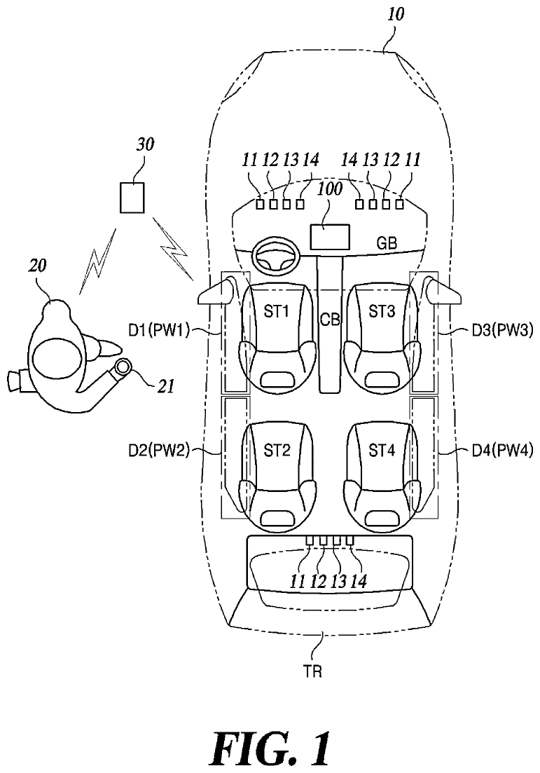

FIG. 1 is a diagram illustrating an autonomous vehicle 10 equipped with an unmanned take-out service providing apparatus 100 according to an embodiment of the present disclosure.

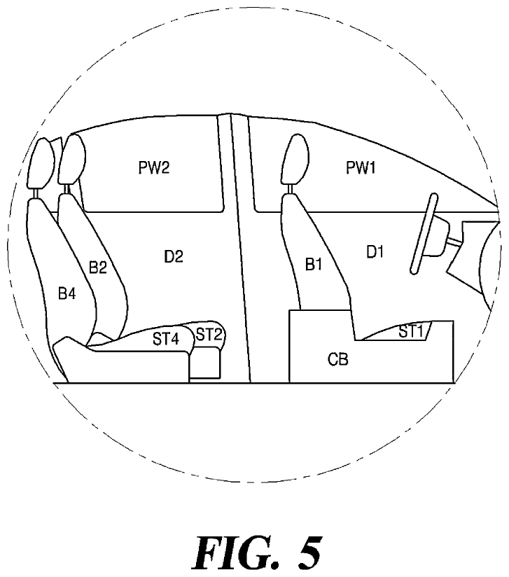

The interior of the autonomous vehicle 10 is provided with a plurality of swivel seats ST1, ST2, ST3, and ST4, and a plurality of doors D1, D2, D3, and D4 are provided to be adjacent to the swivel seats ST1, ST2, ST3, and ST4, respectively. Also, the doors D1, D2, D3, and D4 are provided with windows PW1, PW2, PW3, and PW4, respectively. In addition, a glove box GB may be provided at a lower end of the driver's seat ST1 side or at a lower end of the passenger seat ST3 in a dashboard inside the vehicle 10. A console box CB (see also FIG. 5) may be provided between the driver's seat ST1 and the passenger seat ST3. A trunk TR may be provided on the exterior rear side of the vehicle 10. The positions of small boxes, such as the console box CB and the glove box GB within the vehicle 10 are not limited thereto, and the console box CB and the glove box GB may be installed in various positions.

The swivel seats ST1, ST2, ST3, and ST4 provide a swivel function, as well as forward, backward, vertical height movement functions under the control of the unmanned take-out service providing apparatus 100. Here, the swivel function refers to a function of swiveling based on a vertical axis of a central portion of the bottom of the swivel seats ST1, ST2, ST3, and ST4. In addition, the swivel function may not be necessarily limited to swiveling of the entire body of each seat ST1, ST2, ST3, and ST4 and may refer to a swivel function of only the backrests B1, B2, B3, and B4 in a state in which bottom portions of the seat ST1, ST2, ST3, and ST4 do not swivel.

The unmanned take-out service providing apparatus 100 is mounted on the autonomous vehicle 10 and provides an unmanned take-out service.

The autonomous vehicle 10 is equipped with at least one peripheral device, such as a camera sensor 11, a display device 12 (e.g., a touch screen), a speaker 13, and a microphone 14, and the unmanned take-out service providing apparatus 100 uses the peripheral devices 11, 12, 13, and 14 in the process of providing a service of receiving a product 21 ordered by a user from a product provider 20 at a store. Here, the product provider 20 may be a seller at a store, but the present disclosure is not limited thereto and may include various providers, such as a renter of the ordered product or a person, who simply transfers the ordered product. In the following description, it is assumed that the product provider 20 is a seller.

The camera sensor 11, the display device 12, the speaker 13, and the microphone 14 may be mounted one at a time in the vehicle 10, but at least some of them may be mounted in plural numbers.

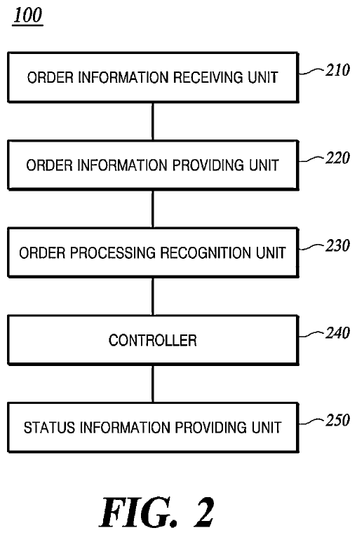

FIG. 2 is a block diagram illustrating a configuration of the unmanned take-out service providing apparatus 100 according to the present embodiment.

The unmanned take-out service providing apparatus 100 according to the present embodiment includes an order information receiving unit 210, an order information providing unit 220, an order processing recognition unit 230, a controller 240, and a status information providing unit 250. Not all blocks shown in FIG. 2 are essential components, and in other embodiments, some blocks included in the unmanned take-out service providing apparatus 100 may be added, changed, or deleted. Meanwhile, the components shown in FIG. 2 represent functionally distinct elements, and at least one component may be implemented in an integrated form in an actual physical environment.

The order information receiving unit 210 receives product order information from the user terminal 30 owned by an orderer, who wishes to order a product.

The user terminal 30 is a device loaded with an application for using the service provided by the unmanned take-out service providing apparatus 100 and may include a smartphone or the like.

The product order information received by the order information receiving unit 210 from the user terminal 30 may include orderer information, details of the ordered product, a size of the ordered product, a delivery date and time of the ordered product, information on a location of a store, and information on the seller 20. Here, the seller 20 is not limited to a store employee but may also be an unmanned sales device of a store or a store robot. In addition, the information on the seller 20 may be specific identification information related to the seller 20, and the specific identification information may include a photo of the seller, fingerprint information, barcode, authentication number, etc.

When receiving product order information from the user terminal 30, the order information receiving unit 210 identifies the information on the delivery date and time of the ordered product and the location of the store included in the product order information and provides the information on the delivery date and time of the ordered product and the location of the store to an autonomous driving function (not shown) in the vehicle 10. Thus, the product may be delivered to the user at the relevant delivery date and time, and the vehicle 10 may move to the store for the ordered product 21.

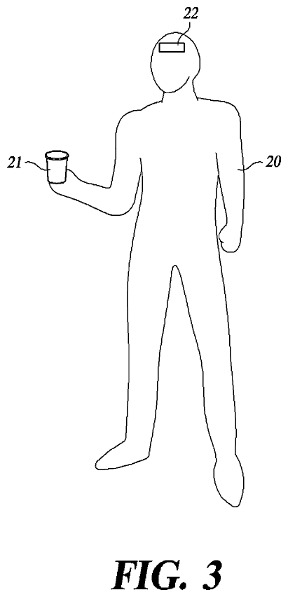

FIG. 3 is a diagram illustrating a form in which the autonomous vehicle 10 identifies the seller 20.

When the autonomous vehicle 10 has completed moving to the ordered product 21 store according to the information on the location of the ordered product 21 store, the order information providing unit 220 provides the product order information to the seller 20 of the ordered product store.

As illustrated in FIG. 3, the order information providing unit 220 may be implemented to recognize specific identification information attached to a specific body part 22 of the seller 20 and then provide product order information to the seller 20 of the ordered product. Specific identification information may be attached to, for example, a hat worn on a specific body part 22 of the seller 20 to be recognized by the order information providing unit 220, but the order information providing unit 220 may be implemented to recognize specific identification information as the seller 20 brings the specific identification information close to the camera sensor 11.

Meanwhile, before the autonomous vehicle 10 completes movement to the corresponding store, i.e., before the vehicle 10 starts moving to the store or while moving to the store, the order information providing unit 220 may be implemented to transmit the corresponding ordered product to the store in advance using a network (not shown) of the vehicle 10.

The order information providing unit 220 provides product order information to the seller 20 of the corresponding store using at least one of the display device 12 and the speaker 13 in the vehicle 10.

For example, the order information providing unit 220 may display product order information including orderer information, details of the ordered product, seller information, etc. to the seller 20 using the display device 12 and may provide product order information by voice to the seller 20 using the speaker 13.

Before product order information is provided to the seller 20, the order information providing unit 220 may provide information that specifies the seller 20 related to the ordered product, such as a name of the seller 20, through the display device 12 or the speaker 13.

In addition, the order information providing unit 220 may be implemented to confirm that the seller 20, who has confirmed the product order information, represents an order reception voice indicating that the order reception has been received using the microphone 14. Here, the order reception voice may be an agreed voice phrase indicating that the order has been properly received.

The order information providing unit 220 verifies the identification information on the seller included in the product order information and acquires identification information by photographing the seller of the corresponding store using the camera sensor 11. The order information providing unit 220 may be implemented to provide product order information to the seller 20 according to a result of comparing the identification information included in the product order information and the identification information acquired by photographing with the camera sensor 11. For example, if the identification information attached to a person in a photo transmitted as specific identification information for the seller is determined to be the same as the identification information attached to a face of the person in the image of the seller captured using the camera sensor 11, the order information providing unit 220 may provide product order information to the seller 20. Here, specific identification information may be a number or barcode.

In addition, the order information providing unit 220 may also be implemented to provide an input unit so that the seller 20 may input fingerprint or iris information as specific identification information, may verify whether information input by the seller 20 using the provided input unit matches specific identification information included in the product order information, and then may provide the product order information to the seller 20.

The order information providing unit 220 may be implemented to provide only the details of the ordered product to the seller 20. According to an embodiment, the order information providing unit 220 may be implemented to further include information of at least a portion of the product order information, in addition to the details of the ordered product, and provide the same to the seller 20.

The order processing recognition unit 230 recognizes the ordered product 21 provided by the seller 20.

The order processing recognition unit 230 may be implemented to recognize the ordered product 21 from a recognition code, for example, a barcode or QR code, attached or displayed on a receipt of the ordered product 21. In this case, a recognition device for recognizing the barcode or QR code may be installed in the vehicle 10.

In addition, the order processing recognition unit 230 may be implemented to recognize whether the product provided by the seller 20 corresponds to the ordered product 21 based on machine learning.

The unmanned take-out service providing apparatus 100 may be implemented to include a payment function for the ordered product when it is verified that the product provided by the seller 20 corresponds to the ordered product 21. In this case, a system for paying for the ordered product may be provided in the vehicle 10. In addition, when the order processing recognition unit 230 recognizes the ordered product 21, the orderer may access a separate payment system to make payment using the user terminal 30.

A method for the orderer to pay the price of the ordered product to the seller 20 using the payment function using the user terminal 30 or the payment function provided in the unmanned take-out service providing apparatus 100 is beyond the gist of the present disclosure, and a detailed description thereof is omitted.

When the payment for the ordered product 21 is completed using the payment function provided in the user terminal 30 or the unmanned take-out service providing apparatus 100, the order processing recognition unit 230 provides a notice indicating that the payment has been completed, as an image or by voice, to the seller 20 using the display device 12 or the speaker 13.

The controller 240 selectively controls at least one of the seats ST1, ST2, ST3, and ST4, the windows PW1, PW2, PW3, and PW4, doors D1, D2, D3, and D4, and the trunk TR of the vehicle 10 according to a position of a space for loading the ordered product in the vehicle 10.

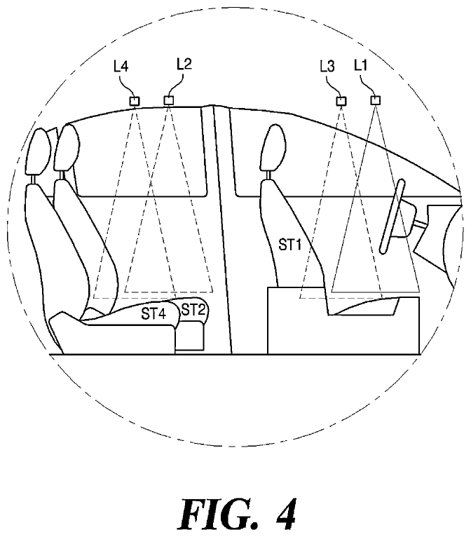

FIG. 4 is a diagram illustrating a lighting control situation in the vehicle 10 when the ordered product 21 is loaded into the vehicle 10, and FIG. 5 is a diagram illustrating a security locking situation inside the vehicle 10 when the ordered product 21 is loaded into the vehicle 10. For reference, it should be noted that, in FIGS. 4 and 5, the shape of the passenger seat ST3 among the seats ST1, ST2, ST3, and ST4 of the vehicle 10 is omitted.

The controller 240 controls lighting associated with each seat ST1, ST2, ST3, and ST4 in the vehicle 10 according to the position of a loading target space in the vehicle 10 for loading the ordered product 21.

In the present embodiment, the loading target space refers to a space in which the ordered product 21 is determined to be loaded, and the loading target space may refer to at least one of each seat ST1, ST2, ST3, and ST4 or the trunk TR. However, the loading target space is not limited to a seat and may be an internal floor near the seats ST1, ST2, ST3, and ST4 or a separate loading box in the vehicle 10.

The controller 240 determines a size of the ordered product 21. If information on the size of the ordered product 21 is included in the product order information, the controller 240 may know in advance the size of the ordered product 21 but may also acquire the size of the ordered product by photographing the ordered product 21 using the camera sensor 11 installed in the vehicle 10.

The controller 240 controls at least one of the window, door, or trunk of the vehicle 10 to be opened depending on the type of seat available in the autonomous vehicle 10 and the kind of ordered product 21.

The controller 240 determines whether the size of the ordered product 21 may be a size that may be loaded on the seats ST1, ST2, ST3, and ST4 in the vehicle 10 or may be a size that is difficult to be loaded on the seats ST1, ST2, ST3, and ST4 but may be loadable in the trunk TR.

If the size of the ordered product 21 is a size that may be loaded on the seats ST1, ST2, ST3, and ST4 in the vehicle 10, the controller 240 searches seats not loaded with other items, among the seats ST1, ST2, ST3, and ST4 in the vehicle 10 for a seat that can be loaded with the ordered product 21. The controller 240 determines a loading target seat of the ordered product 21 according to a preset priority among the seats on which the ordered product 21 can be loaded.

For example, when the driver's seat ST1 is determined to be the seat for loading the ordered product 21, as shown in FIG. 4, the controller 240 turns on lighting LI that emits light to the driver's seat ST1, which is the corresponding seat, and controls to turn off lightings L2, L3, and L4 that emit light to the other seats ST2, ST3, and ST4, among lightings L1, L2, L3, and L4 respectively illuminating the seats ST1, ST2, ST3, and ST4 in the vehicle 10.

In addition, when it is determined that the size of the ordered product 21 may be inserted into the vehicle 10 through the windows PW1, PW2, PW3, and PW4, the controller 240 controls the windows PW1, PW2, PW3, and PW4 adjacent to the loading target seats to be opened. In this case, the controller 240 controls each door D1, D2, D3, and D4 to be locked.

In addition, although the size of the ordered product 21 is not large enough to be inserted into the vehicle 10 through the windows PW1, PW2, PW3, and PW4 but may be inserted into the vehicle 10 through the doors D1, D2, D3, and D4, the controller 240 controls the door adjacent to the seat to be loaded so that the door may be opened. For example, when the driver's seat ST1 is determined to be the seat for loading the ordered product 21, the controller 240 unlocks the door DI adjacent to the driver's seat ST1 to be opened and controls the remaining doors D2, D3, and D4 to be locked. Also, in this case, each window PW1, PW2, PW3, and PW4 may be controlled to be locked.

Before controlling at least one of the window PW1, PW2, PW3, or PW4 or at least one of the doors D1, D2, D3, or D4 to be unlocked, the controller 240 controls the small box, such as the console box CB and the glove box, to be locked.

When the size of each seat ST1, ST2, ST3, and ST4 in the vehicle 10 is smaller than the size of the ordered product 21 when the ordered product 21 is determined to be inappropriate to be loaded on the seats ST1, ST2, ST3, and ST4, the controller 240 may control the trunk TR to be opened and controls lighting in the trunk TR to be turned on. Whether the product is inappropriate to be loaded on the seats ST1, ST2, ST3, and ST4 may be determined by the controller 240 by determining the status of the ordered product 21 using machine learning.

In addition, if the product order information includes loading target space information, the controller 240 checks the loading target space information in the product order information and controls unlocking and lighting, etc. for the corresponding loading target space so that the ordered product 21 is loaded in the corresponding loading target space.

Before controlling the trunk TR to be opened, the controller 240 may control the windows PW1, PW2, PW3, and PW4 or the doors D1, D2, D3, and D4 to be locked for security purposes.

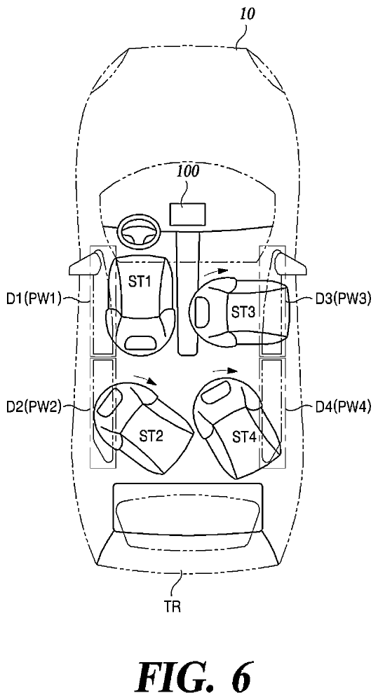

FIG. 6 is a diagram illustrating an example of swiveling at least one seat ST1, ST2, ST3, and ST4 according to the position of the seats ST1, ST2, ST3, and ST4 on which the ordered product 20 is to be loaded.

The controller 240 swivels at least one seat ST1, ST2, ST3, and ST4 in the vehicle 10 based on which seat is the target seat for loading the ordered product 21 in the vehicle 10. Here, swiveling the seats ST1, ST2, ST3, and ST4 may not refer to simply swiveling but securing a swiveling space of each seat ST1, ST2, ST3, and ST4 through forward/backward and left/right movement of the seats ST1, ST2, ST3, and ST4 in the vehicle 10 and swiveling each seat ST1, ST2, ST3, and ST4.

For example, when the loading target seat is the driver's seat ST1, the controller 240 swivels the remaining seats ST2, ST3, and ST4 as indicated by the arrows in FIG. 6, so that backrests B2, B3, and B4 of the remaining seats ST2, ST3, and ST4 face the driver's seat ST1, the seat to be loaded so that other items loaded on the remaining seats ST2, ST3, and ST4 are not exposed toward the driver's seat ST1.

In this case, the controller 240 may control to swivel only the seat on which other items are loaded among the remaining seats ST2, ST3, and ST4 excluding the loading target seat ST1 and not swivel the seat on which other items are not loaded, among the remaining seats ST2, ST3, and ST4.

The controller 240 may determine whether other items are loaded in the remaining seats ST2, ST3, and ST4 from a separate sensor installed in each seat, or if information on whether an item exists in each of the seats ST1, ST2, ST3, and ST4 is included in the product order information transmitted by the user terminal 20, the controller 240 may be implemented to determine whether other items are loaded in the remaining seats ST2, ST3, and ST4 using the information.

The controller 240 determines whether the ordered product 21 is loaded in a designated loading target space in the vehicle 10 using the camera sensor 11 or the barcode sensor.

Meanwhile, when the seller 20 loads the ordered product 21 into the designated loading target space using the camera sensor 11, etc., the controller 240 determines whether the seller 20 approaches a space other than the designated loading target space in the vehicle 10. If the seller 20 approaches the designated loading target space, the controller 240 performs recording using the camera sensor 11, etc. and issues a warning using the speaker 13 to prevent the theft of items in the vehicle 10.

The status information providing unit 250 may provide the user terminal 30 with delivery information including a movement path of the vehicle 10, in-vehicle conditions including a loading status of items in the vehicle 10, and traffic conditions during movement.

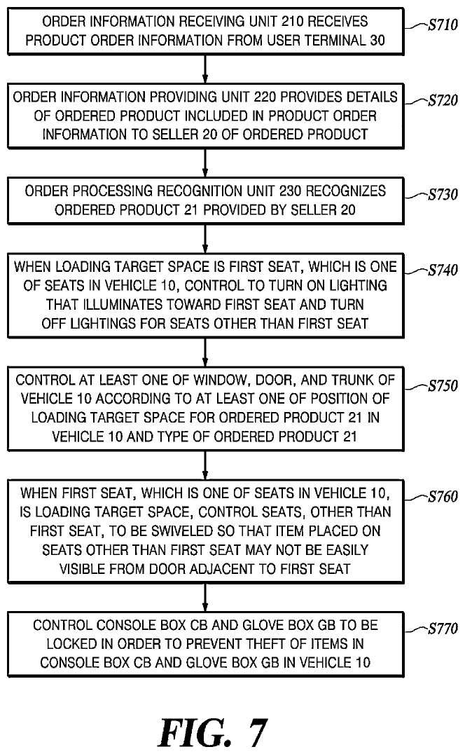

FIG. 7 is a flowchart illustrating a method for the unmanned take-out service providing apparatus 100 to provide an unmanned take-out service according to an embodiment of the present disclosure.

The order information receiving unit 210 receives product order information from the user terminal 30 (S710). The order information receiving unit 210 may include, as product order information, orderer information, details of the ordered product, ordered product delivery date and time, information on a location of a store, information on the seller 20, and the presence or absence of an item loaded in each of the seats ST1, ST2, ST3, and ST4.

The order information providing unit 220 provides the details of the ordered product included in the product order information to the seller 20 of the ordered product (S720). The order information providing unit 220 may recognize the seller 20 using a sensor device, such as the camera sensor 11 or the microphone 14 before providing the details of the ordered product to the seller 20. Once recognition of the seller 20 is completed, the order information providing unit 220 provides orderer information or contacts the seller 20 using the display device 12 or the speaker 13.

The order processing recognition unit 230 recognizes the ordered product 21 provided by the seller 20 (S730). The order processing recognition unit 230 performs payment for the product when payment is necessary. The order processing recognition unit 230 recognizes a size of the ordered product 21 and determines whether the ordered product 21 may be loaded on the seat or trunk of the vehicle 10.

When the loading target space is a first seat, which is one of the seats in the vehicle 10, the controller 240 controls to turn on lighting that illuminates toward the first seat and turn off the lightings for the seats other than the first seat (S740).

The controller 240 controls at least one of the window, door, and trunk of the vehicle 10 according to at least one of the position of the loading target space for the ordered product 21 in the vehicle 10 or the type of the ordered product 21 (S750). If the loading target space is one of the seats in the vehicle 10 and the ordered product 21 may be loaded into the loading target space through a window, the window of the corresponding seat is opened and each door is locked. The loading target space is one of the seats 10 in the vehicle, and if it is difficult to load the ordered product 21 into the loading target space through the window and the door adjacent to the corresponding seat should be opened to load the ordered product 21 into the loading target space, the controller 240 controls the corresponding door to be in an openable state and controls the remaining doors to be in a locked state. If there is no loading target space among the seats in the vehicle 10 or if the ordered product 21 are too large to be loaded into the loading target space even when the door is opened, the controller 240 controls to open the trunk TR to load the ordered product 21 into the loading target space.

When the first seat, which is one of the seats in the vehicle 10, is a loading target space, the controller 240 controls the seats, other than the first seat, to be swiveled so that the item placed on the seats other than the first seat may not be easily visible from the door adjacent to the first seat (S760). At this time, the backrest portions of the other seats may be controlled to face in the direction of the first seat.

The controller 240 controls the console box CB and glove box GB to be locked in order to prevent theft of items in the console box CB and glove box GB in the vehicle 10 (S770).

Each component of the apparatus or method according to the present disclosure may be implemented as hardware or software, or a combination of hardware and software. Further, the function of each component may be implemented as software and a microprocessor may be implemented to execute the function of software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device and may further include a transitory medium such as a data transmission medium. In addition, the computer-readable recording medium may be distributed in a computer system connected via a network, so that computer-readable codes may be stored and executed in a distributed manner.

The flowchart/timing diagram of the present specification describes that processes are sequentially executed, but this is merely illustrative of the technical idea of an embodiment of the present disclosure. In other words, because it is apparent to those having ordinary skill in the art that an order described in the flowchart/timing diagram may be changed or one or more processes may be executed in parallel without departing from the essential characteristics of an embodiment of the present disclosure, the flowchart/timing diagram is not limited to a time-series order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the present embodiments is not limited by the illustrations. Accordingly, one of ordinary skill should understand that the scope of the present disclosure is not to be limited by the above explicitly described embodiments but by the claims and equivalents thereof.

What is claimed is:

1. An apparatus comprising:
a memory configured to store instructions; and
a processor configured, by executing the instructions, to:
receive order information from a user terminal;
provide details of an ordered object included in the order information to a provider of the ordered object;
recognize the ordered object provided from the provider; and
control at least one of a seat, a window, a door, or a trunk of a vehicle based on a position of a loading target space for the ordered object in the vehicle.

2. The apparatus of claim 1, wherein the order information includes at least one of orderer information related to the order information, the details of the ordered object, delivery date and time of the ordered object, a location information of a store, or information on the provider.

3. The apparatus of claim 1, wherein the processor is further configured, by executing the instructions, to:
provide the details of the ordered object to the provider using at least one of a display device or a speaker in the vehicle.

4. The apparatus of claim 1, wherein the processor is further configured, by executing the instructions, to:
recognize identification information related to the provider using a sensor; and
provide the details of the ordered object to the provider.

5. The apparatus of claim 4, wherein the processor is further configured, by executing the instructions, to:
provide the details of the ordered object to the provider in case that the identification information related to the provider recognized using the sensor matches to the identification information of the provider included in the order information.

6. The apparatus of claim 1, wherein the processor is further configured, by executing the instructions, to:
recognize the ordered object by a recognition code related to the ordered object.

7. The apparatus of claim 1, wherein the processor is further configured, by executing the instructions, to:
control lighting of a seat in the vehicle according to a position of the loading target space for the ordered object.

8. The apparatus of claim 7, wherein the processor is further configured, by executing the instructions, to:
control to turn on the lighting that emits light to a loading target seat for the ordered object; and
turn off the lighting that illuminates other seats in the vehicle.

9. The apparatus of claim 1, wherein the processor is further configured, by executing the instructions, to:
control to swivel at least one seat in the vehicle based on which seat is a loading target seat in the vehicle for the ordered object.

10. The apparatus of claim 9, wherein the processor is further configured, by executing the instructions, to:
control to swivel other seats to adjust an arrangement of the other seats, in case that other items are loaded on seats in the vehicle other than the loading target seat.

11. The apparatus of claim 10, wherein the order information includes information on whether objects are loaded for each seat in the vehicle.

12. A method comprising:
performing an order information receiving process by receiving order information from a user terminal;
performing an order information providing process by providing details of an ordered object included in the order information to a provider of the ordered object;
performing an order processing recognizing process by recognizing the ordered object provided from the provider; and
performing a control process by controlling at least one of a seat, a window, a door, or a trunk of a vehicle based on a position of a loading target space for the ordered object in the vehicle.

13. The method of claim 12, wherein the order information includes at least one of orderer information related to the order information, the details of the ordered object, delivery date and time of the ordered object, a location information of a store, or information on the provider.

14. The method of claim 12, wherein performing the order information providing process includes:
recognizing identification information related to the provider using a sensor; and
providing the details of the ordered object to the provider.

15. The method of claim 12, wherein performing the control process includes:
controlling to turn on a lighting that emits light to a loading target seat for the ordered object; and
10 controlling to turn off the lighting that illuminates other seats in the vehicle.

16. The method of claim 12, wherein performing the control process includes controlling to swivel at least one seat in the vehicle based on which seat is a loading target seat in the vehicle for the ordered object.
